(19) United States
(12) Patent Application Publication
(10) Pub. No.: US 2006/0010476 A1
(43) Pub. Date: Jan. 12, 2006

(54) Method for concurrently presenting multiple content types in a tv platform

(76) Inventors: Declan Patrick Kelly, Eindhoven (NL); Philip Steven Newton, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/535,481

(22) PCT Filed: Oct. 29, 2003
(86) PCT No.: PCT/IB03/04798

§ 371 Date: May 18, 2005

Related U.S. Application Data
(60) Provisional application No. 60/427,421, filed on Nov. 19, 2002.

(51) Int. Cl. H04N 7/173

(52) U.S. Cl. 725/86

(57) ABSTRACT

A first content is received and presented to a user on a television (TV) platform (16). A second content is also received and presented concurrently to the user. In an interactive TV platform (16), a user selects the second content. In one aspect, the first content is advertising content (40) and the second content is information content (46), electronic mail content (42), downloadable file content (44), or program content (32, 34, 36, 38). In another aspect, the first content is program content (32, 34, 36, 38) and the second content is one of information content (46), electronic mail content (42), advertising content (40), and downloadable file content (44).

The invention relates to the video arts. It finds particular application in conjunction with providing additional content along with advertisement content in an interactive TV platform, such as overlaying user-selected information content on advertisement content, and will be described with particular reference thereto. However, it is to be appreciated that the invention is also amenable to other applications. For example, the invention also contemplates overlaying information content on program content and presenting audio advertisements with program content when the program content has trivial or no accompanying audio.

The basic architecture and communications standards for interactive TV are known in the art. The TV-Anytime (TVA) Forum, for example, is an association of organizations that defines specifications to enable applications to exploit persistent personal media storage in consumer electronic (CE) platforms, such as interactive TV platforms. The TVA Forum is network independent with regard to the means for content delivery to the CE platform, including various digital TV (DTV) delivery mechanisms, as well as the Internet and enhanced TV systems. The TVA Forum has established fundamental specifications for the services, systems, and devices to provide interoperable and integrated systems from content creators/providers, through service providers, to consumers.

The current specification produced by the TVA Forum includes five “S-series” documents: 1) S-1 Benchmark Features, 2) S-2 System Description, 3) S-3 Metadata, 4) S-4 Content Referencing, and 5) S-5 Rights Management. The S-1 specification enables search, select, acquire, and rightful use of content on local and/or remote personal storage systems from both broadcast and online services. The S-2 specification identifies the behavior of a TVA broadcast system with an interaction channel used for consumer response. The S-3 specification defines metadata schemas and how they are used within the end-to-end TVA system. Metadata, as defined by TVA, includes descriptive data about content, such as program title and synopsis, referred to as “attractors,” as well as information about user preferences and history. The S-4 specification defines the content referencing process that begins after a content item has been selected by a consumer through to, but not including, the actual acquisition of the desired content item.

The Multimedia Home Platform (MHP) specification, published jointly by the European Telecommunications Standards Institute (ETSI) and the European Broadcasting Union (EBU), for example, provides a standardized technical solution for a user terminal or platform that enables the reception and presentation of applications in a vendor, author, and broadcaster neutral framework. Under the MHP specification, applications from various service providers are interoperable with different MHP platforms. Thus, applications, networks, and MHP terminals can be made available by multiple independent providers.

Chapter 13 of the MHP specification defines the graphics reference model implemented. Via the graphics reference model, MHP provides tools to control the positioning of video on an output device, interface components, such as buttons and lists, as well as raw graphical primitives. A screen constructed under MHP has three planes which are, from back to front, a background plane, a video plane, and a graphics plane. An application is provided with a contiguous rectangular region of the graphics plane in which it can draw. An application can place video, interface elements, and graphics inside its rectangle on the graphics plane. An application can also control video outside of an abstract windowing toolkit (AWT) hierarchy on the video plane, and place still images or solid color in the background plane. The MHP specification enables terminals to support multiple applications at any one time, each of which can have a sub area of the screen to which it can draw. The specification enables the areas to overlap. If the presentations of different applications overlap, the areas obscured by other applications are clipped. Therefore, where an application is translucent it will be blended with the video or background image behind it rather than being blended with another application.

Moreover, the distribution of advertisement via television is well established. Advertisers typically purchase advertisement time on a specific channel and time period with the rate being set by the popularity of programs airing within the time period. The more popular the underlying program or time slot, the more expensive the advertising rate. With the increase in the number of network stations, advertisers are confronted with the task of determining which stations are appropriate for their products or services. It is also difficult for advertisers to select a type of advertisement that will appeal to a broad cross section of the population (e.g., males, females, young and old).

Furthermore, from a consumer's perspective, the inability of the consumer to control the content of advertisement information is one of the most irritating aspects related to advertising. The user can only watch what is presented and cannot switch between different advertisements as he can with programs or interact with the advertisement.

New technology makes skipping commercials even easier than before. Consumers today often skip commercials that they do not want to see. However, commercials pay for almost everything on commercial television. High-priced shows are paid for by the value that advertisers perceive in displaying their ads during the show. As commercials become less effective, more ad dollars are being devoted to product placement within the television shows. For example, advertisers pay high prices for an actor to use their product in a show. Ideally, advertisers want to deliver a message appropriate for each user. Advertisers are willing to pay higher costs for even better user focus than merely a group of people watching a specific show.

There is, therefore, a need for a method to keep users interested during advertisements so that they do not switch to another channel.

In one aspect of the invention, a method for concurrently presenting multiple content types on a video platform is provided. A first content associated with a first content type is received. A second content associated with a second content type is also received. The first and second content are presented to the user concurrently. In one embodiment of this method, the first content is program content and the second content is audio advertisement content.

In another embodiment of the invention, a video platform for concurrently presenting multiple content types is provided. The video platform includes: a means for receiving a first content associated with a first content type, a means for receiving a second content associated with a second content type, and a means for concurrently presenting the first content and the second content in a human viewable display.

One advantage of the invention is that viewers of an interactive television (TV) platform are provided incentives to continue to watch advertisement content rather than change the channel to another program during an advertisement.

An additional advantage is that viewers of an interactive TV platform are provided with an option of continuing to watch program content while also interacting with additional content.

Another additional advantage is that service providers benefit from viewers continuing to watch advertising content and program content when they may have otherwise discontinued watching.

Another additional advantage is that service providers can combine audio advertisement content with program content when there is no audio associated with the program content or when the audio normally associated with the program content is trivial.

Other advantages will become apparent to those of ordinary skill in the art upon reading and understanding the following detailed description.

The drawings are for purposes of illustrating exemplary embodiments of the invention and are not to be construed as limiting the invention to such embodiments. It is understood that the invention may take form in various components and arrangement of components and in various steps and arrangement of steps beyond those provided in the drawings and associated description. Within the drawings, like reference numerals denote like elements and similar reference numerals (e.g., 116, 216) denote similar elements.

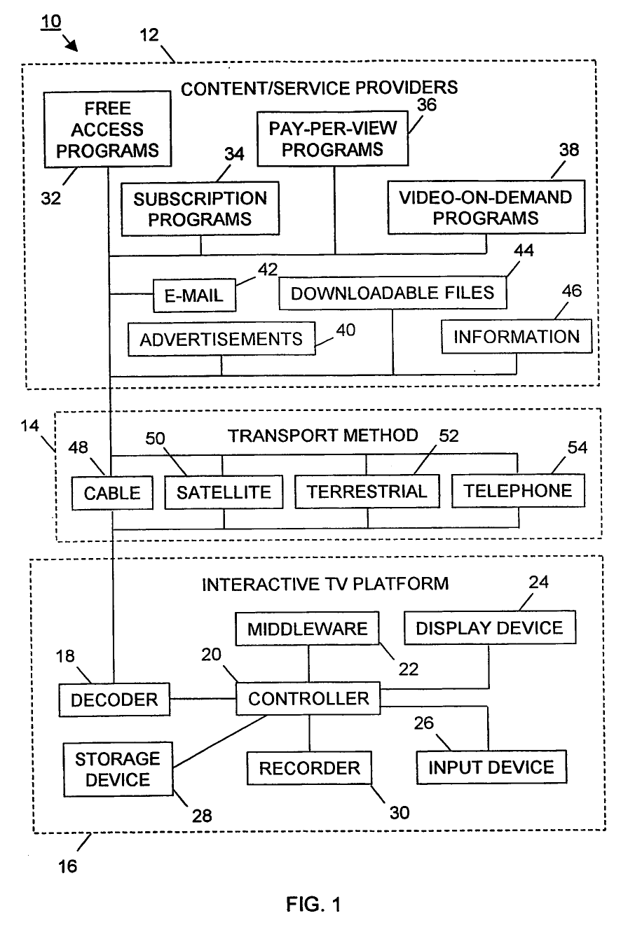

FIG. 1 is a block diagram of a communications environment for interactive television (TV) incorporating the invention.

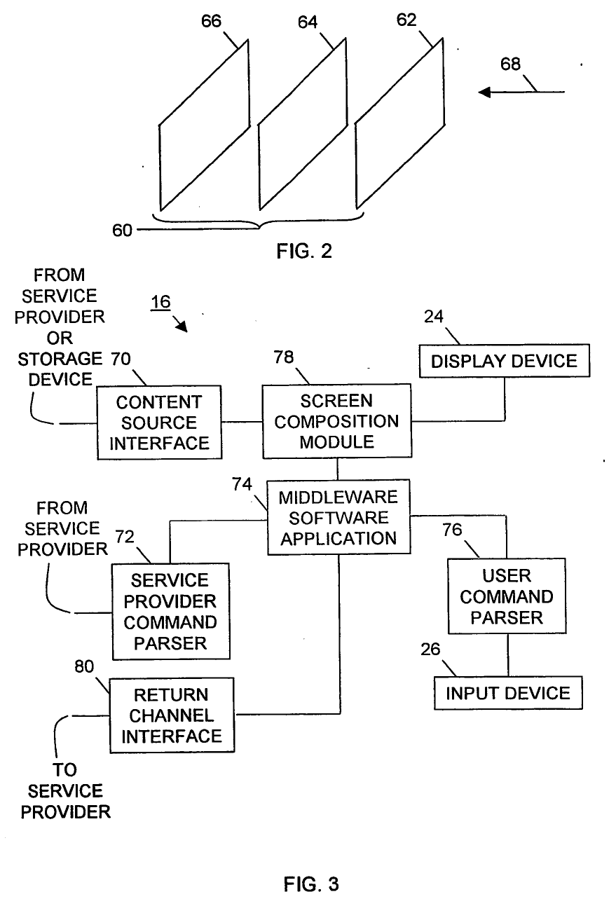

FIG. 2 is a diagram showing a method of screen composition in a TV platform incorporating the invention.

FIG. 3 is a block diagram of an embodiment of an interactive TV incorporating the invention.

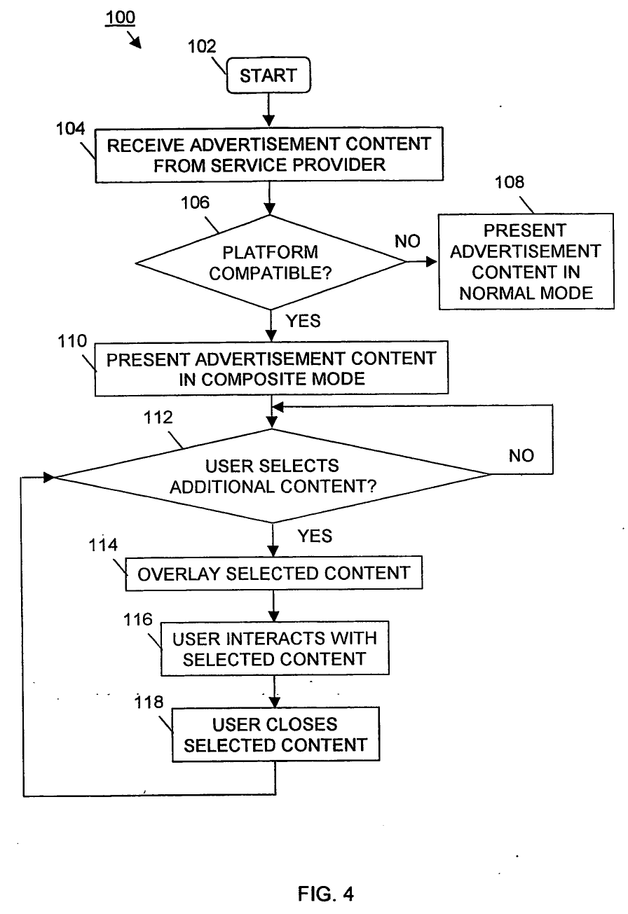

FIG. 4 is a flowchart of an embodiment of a method for presenting multiple content types in an interactive TV platform.

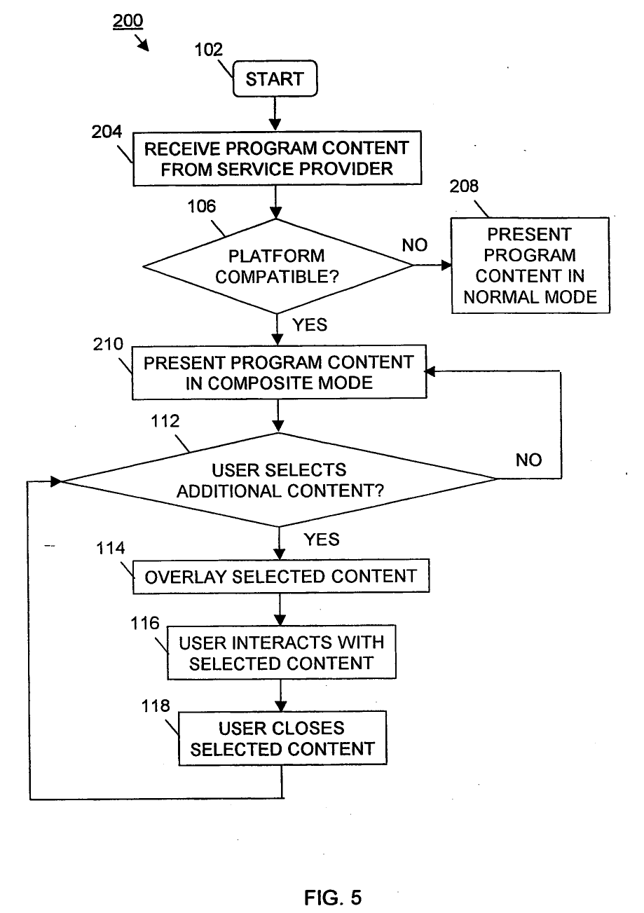

FIG. 5 is a flowchart of another embodiment of the method for presenting multiple content types in an interactive TV platform.

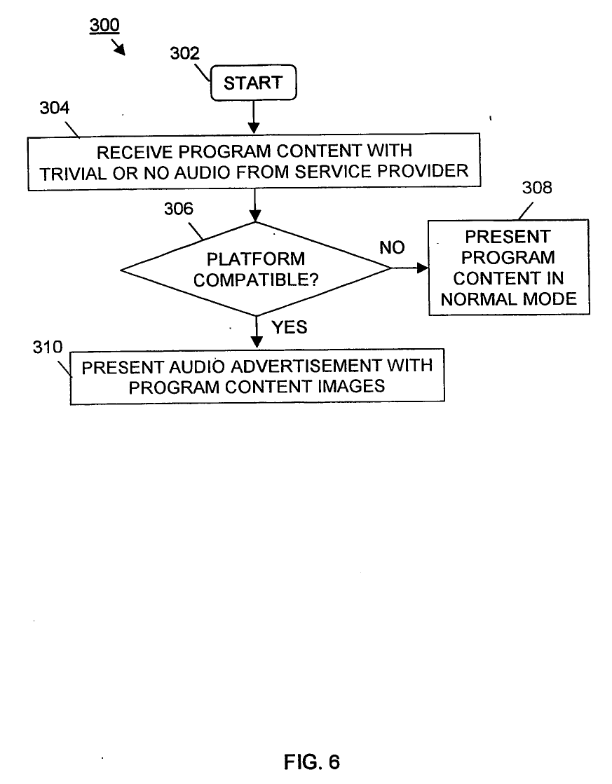

FIG. 6 is a flowchart of an embodiment of a method for presenting multiple content types in a compatible TV platform.

With reference to FIG. 1, a communications environment 10 includes a content/service provider subsystem 12, a transport method subsystem 14, and an interactive television (TV) platform 16. Generally, the content/service provider subsystem 12 provides the interactive TV platform 16 with access to scheduled and on-demand content via the transport method subsystem 14.

The content/service provider subsystem 12 includes multiple types of content, including free access programs 32, subscription programs 34, pay-per-view (PPV) programs 36, video-on-demand (VOD) programs 38, advertisements 40, E-mail 42, downloadable files 44, and information 46. The information content 46 can be any form of information, including topics such as news, weather, travel, and entertainment. In particular, information content 46 is intended to encompass the variety of information available via Web browsing. Preferably, a communications environment 10 incorporating the invention includes at least one type of scheduled (e.g., free access, subscription, or PPV) or on-demand (e.g., VOD) program content (32, 34, 36, 38), advertisement content 40, and at least one type of additional content (e.g., E-mail, downloadable files, or information) (42, 44, 46). This subsystem includes any of the various types of content from terrestrial broadcasters, cable and satellite TV service providers, residential/commercial, cellular, and satellite telephone service providers, and Internet service providers. Any type of service provider may offer interactive TV services. A service provider offering such services is subsequently referred to as an interactive TV service provider.

The transport method subsystem 14 includes at least one of cable 48, satellite 50, terrestrial 52, and telephone 54. The cable transport method 48 is primarily associated with cable TV service providers. The satellite transport method 50 is primarily associated with satellite TV and satellite telephone service providers. The terrestrial transport method is primarily associated with terrestrial broadcasters and cellular telephone service providers. The telephone transport method is primarily associated with residential/commercial telephone service providers. Internet service providers may utilize any type of the transport method. Likewise, an interactive TV service provider may utilize any type of the transport method. In particular, an interactive TV service provider may provide users with links to content from other service providers, such as Internet service providers.

The interactive TV platform 16 includes a decoder 18, a controller 20, middleware 22, a display device 24, and an input device 26. The interactive TV platform 16 may also include a storage device 28 and a recorder 30. The basic module of the interactive TV platform 16 may be packaged in various configurations. For example, all of the modules may be packaged in an interactive TV. Alternatively, the decoder 18, controller 20, and middleware 22 may be packaged in a set-top box. In this alternative, the display device 24 may be an analog or digital TV, the input device 26 may be a remote or wired control associated with the set-top box, and the storage device 28 and recorder 30 may be a personal video recorder. Many other configurations are possible. The invention does not require or rely on any particular packaged configuration. In particular, control functions of the controller 20 may be divided between a set-top box and a TV.

Typically, in between segments of program content (e.g., 32, 34, 36, 38) an interactive TV service provider transmits advertisement content 40. The interactive TV service provider may also periodically or selectively transmit enabling and control commands. For instance, the interactive TV service provider may transmit enabling and control commands associated with advertisement content 40 that permit a subscriber with a compatible interactive TV platform 16 to select additional content to be viewed during the time the advertising content 40 is transmitted. The additional content may include E-mail 42, downloadable files 44, information 46, or other viewable material.

The decoder 18 receives all transmission from the interactive TV service provider and communicates decoded content and commands to the controller 20. The controller 18 parses commands from the interactive TV service provider. The controller 20 operates according to software modules within the middleware 22. When commands are received from the interactive TV service provider, the commands are acted upon by the controller 20 according to the middleware 22. Similarly, the controller 20 receives and parses user commands from the input device 26 and acts upon such commands according to the middleware 22. The controller 20 creates composite screens for presentation on the display device 24 based on various combinations of middleware software modules 22, service provider commands, and user commands.

Within this framework, the interactive TV service provider can enable user selection of additional content during the viewing of advertising content either automatically or selectively. Selection of the additional content may be based on service provider commands or a combination of service provider and user commands. For example, the screens presented on the display device 24 at the beginning of advertising content may include menus, icons, or other types of controls with which the user can interact to select alternate content for viewing along with the advertisement content. Once selected, the additional content is overlaid on the advertising content. In alternate embodiments, the additional content may placed in a portion of the screen on top of or adjacent to the advertising content.

The menus, icons, and controls may be retained, updated, or removed once additional content is selected. Where they are retained or updated, the user may close the additional content and/or select alternate additional content. Once the advertising content is complete, the middleware may stop the display of the additional content or the service provider may terminate transmission of the additional content or transmit disabling commands.

The additional content makes the advertisement content more attractive to users. Typically, the background associated with the additional content is transparent so that the advertisement is still clearly visible to users on the display device 24. Similarly, the additional content can be presented in a portion of the screen (e.g., scrolling stock ticker or news headlines bands). The additional content, for example, can come from the Internet, from teletext, or from terrestrial broadcast. The additional content can be information content related to the program content preceding the advertisement content, such as interesting facts about actors or show or a textual version of the latest news. Each of these variations of the invention gives the user an extra reason to keep watching the advertisement content.

In another embodiment, the interactive TV service provider can enable user selection of additional content during the viewing of program content either automatically or selectively. In still another embodiment, the interactive TV service provider can automatically provide audio advertisement content in combination with video from program content for a segment of the program where either the normal audio provided with the program content is trivial or no audio is provided. For example, during an interactive program (e.g., a game show) during a period set aside for the user to interact with the program. Shows with live audiences can show the stage preparations that only the live audience sees during commercial breaks as the background with the advertising content on the foreground.

In any of the various embodiments, the interactive TV service provider can transmit commands in the normal content stream to indicate to the controller 20 associated with the interactive TV platform 16 that it can overlay interesting information (e.g., information related to scheduled or on-demand program content) on the display device 24. Also, the interactive TV service provider could include a software application in the middleware 22 that displays some interesting extra facts related to program content on top of the advertisement content. To receive the extra information, the user continues to watch and listen to the advertisement content. Hence, the extra information provides an incentive to users to not change channels during the advertisement.

With reference to FIG. 2, a composite screen 60 composed by the controller 20 based on the middleware software modules in combination with service provider and user commands includes multiple planes. When viewed from a direction 68 (i.e., a user perspective), the composite screen includes at least a first plane 62 and a second plane 64. The composite screen 60 may include many additional planes, for example, a third plane 66. The graphics reference model implemented for Multimedia Home Platform (MHP), for example, includes three planes which are referred to as a graphics plane, a video plane, and a background plane from a user's perspective.

The multiple planes of the composite screen 60 offer a number of options to the middleware 22, service provider, and user for construction of the screen. For example, images, such as motion video, still frame video, graphics, and text, can by positioned, scaled, and cropped on any plane. Images can simultaneously be placed on multiple planes. Images can be selectably solid or translucent to create a desired affect with respect to overlapping images.

For example, a solid image on the first plane 62 will cover overlapping regions of an image on the second plane 64, while a translucent image on the first plane 62 will be merged with the image on the second plane 64. Similarly, a background of an image can be transparent, while a foreground can be solid or translucent. This alternative is typically associated with text objects. For example, a text object on the first plane can have a transparent background and the solid foreground. This results in the text being overlaid on overlapping portions of the image on the second plane 64.

With reference to FIG. 3, an interactive TV platform 16 includes the display device 24 (FIG. 1), input device 26 (FIG. 1), a content source interface 70, a service provider command parser 72, a middleware software application 74, a user command parser 76, a screen composition module 78, and a return channel interface 80. The content source interface 70 and return channel interface 80 are typically associated with the decoder 18 (FIG. 1). The service provider command parser 72, user command parser 76, and screen composition module 78 are typically associated with the controller 20 (FIG. 1). The middleware software application 74 is associated with the middleware 22 (FIG. 1). However, elements 70-80 may also be arranged in various combinations between the decoder 18, controller 20, and display device 24.

The content source interface 70 receives content from service providers or storage devices 28 (FIG. 1). Multiple content source interfaces 72 may be utilized simultaneously, for example, when an interactive TV service provider permits a subscriber to also receive content from the Internet via a different service provider. Content is communicated from the content source interface 70 to the screen composition module 78.

The service provider command parser 72 receives commands from service providers. Service provider commands are communicated to the middleware software application 74. Similarly, the user command parser 76 receives commands from the input device 26 and user commands are communicated to the middleware software application 74.

The middleware software application 74 controls the screen composition module 78 according to programmed instructions contained in modules of the application and service provider and user commands. The screen composition module 78 positions, scales, and crops images from the content source interface within the multiple planes of the composite screen 60 (FIG. 2) to produce a desired layout for the images. The screen composition module 78 also controls attributes of the images (e.g., solid, translucent, transparent background, color, shading, etc.) to produce a desired presentation of the composite screen 60 (FIG. 2) on the display device 24.

With reference to FIG. 4, a method 100 for presenting multiple content types in an interactive TV platform begins at a step 102. Next, at a step 104, advertisement content is received from a service provider. At a step 106, a determination is made as to whether the interactive TV platform is compatible with providing additional content along with the advertisement content. This can involve an identity check to determine if the interactive TV is compatible or a security type check to determine if the user is a valid subscriber and in good standing with the service provider. If the interactive TV platform is not compatible, the process advances to a step 108 where the advertisement content is presented in a normal mode and the process ends when the advertisement content ends.

If the interactive TV platform is compatible, the process advances to a step 110 where the advertisement content is presented in a composite mode. Typically, a menu, icons, or other controls are presented to a user along with the advertisement content. At a step 112, the process determines if a user has selected additional content. If the user never selects additional content, the process merely continues presenting the advertisement content until it ends where the process also ends.

If the user selects additional content, the selected content is overlaid on the advertisement content at a step 112. The advertisement content and additional content form a composite screen that may be controlled in various manners, such as those described above in reference to FIGS. 1-3. If the user performs no further actions, the process ends when the advertisement content ends. Typically, additional content being viewed when the advertisement content ends is also ended.

Optionally, while the advertisement content and additional content are being viewed the user may interact with the selected content (step 116) or close the selected content (step 118). Interacting with the selected content in the step 116 may include browsing or scrolling through the additional content or selecting alternate additional content. Of course, if alternate additional content is selected the process returns to step 114 to overlay the selected content. If the user closes the selected content in the step 118, the process returns to step 112 to determine when the user selects additional content.

With reference to FIG. 5, a method 200 for presenting multiple content types in an interactive TV platform begins at a step 102. The method 200 is similar to the method 100 of FIG. 4. Method 200 incorporates an alternate embodiment of the invention by presenting the additional content in combination with scheduled or on-demand program content (e.g., free access programs 32, subscription programs 34, PPV programs 36, VOD programs 38). As shown, the unique steps in method 200 are steps 204, 208, and 210. At the step 204, program content rather than advertisement content is received from a service provider. At the steps 208 and 210, the program content rather than the advertisement content is presented All other steps are performed in the same manner in method 200 as described above for method 100.

With reference to FIG. 6, a method 300 for presenting multiple content types in a TV platform begins at a step 302. Next, at a step 304, program content with trivial or no audio is received from a service provider. At a step 306, a determination is made as to whether the TV platform is compatible with providing additional content along with the program content. Like for method 100, in method 300 this can involve an identity check of the TV or a security type check of the user. If the TV platform is not compatible, the process advances to a step 308 where the program content is presented in a normal mode and the process ends when the program content ends.

If the TV platform is compatible, the process advances to a step 310 where an audio advertisement is presented in combination with the image(s) associated with the program content is presented. The process continues until either the program content ends or the audio associated with the program content becomes meaningful. This type of change in the audio content may either be recognized by the service provider or by middleware 22 (FIG. 1) associated with the TV platform. If the change is recognized by the service provider, the service provider may end the audio advertisement or transmit a command to disable the audio advertisement. If the change is recognized by the middleware 22 (FIG. 1), the middleware disables the audio advertisement.

While the invention is described herein in conjunction with exemplary embodiments, it is evident that many alternatives, modifications, and variations will be apparent to those skilled in the art. Accordingly, the embodiments of the invention in the preceding description are intended to be illustrative, rather than limiting, of the spirit and scope of the invention. More specifically, it is intended that the invention embrace all alternatives, modifications, and variations of the exemplary embodiments described herein that fall within the spirit and scope of the appended claims or the equivalents thereof.

1. A method for concurrently presenting multiple content types on a video platform comprising:
a) receiving a first content associated with a first content type;
b) receiving a second content associated with a second content type; and
c) concurrently presenting the first content and the second content to the user via the video platform.

2. The method as set forth in claim 1 wherein the video platform is an interactive television platform.

3. The method as set forth in claim 2, further including:
before step b), receiving a user command to select the second content.

4. The method as set forth in claim 3 wherein the first content and the second content are combined to form a composite screen.

5. The method as set forth in claim 4 wherein the first content is advertisement content.

6. The method as set forth in claim 5 wherein the second content is selected from the group consisting of information content, electronic mail content, downloadable file content, and program content.

7. The method as set forth in claim 4 wherein the first content is program content.

8. The method as set forth in claim 7 wherein the second content is selected from the group consisting of information content, electronic mail content, downloadable file content, and advertisement content.

9. The method as set forth in claim 4 wherein the second content includes text with a transparent background and overlays at least a portion of the first content.

10. The method as set forth in claim 4 wherein the second content includes at least one graphics object and overlays at least a portion of the first content.

11. The method as set forth in claim 10 wherein the second content is translucent.

12. The method as set forth in claim 4 wherein the second content includes at least one video object and overlays at least a portion of the first content.

13. The method as set forth in claim 12 wherein the second content is translucent.

14. The method as set forth in claim 1 wherein the first content is program content.

15. The method as set forth in claim 14 wherein the second content is audio advertisement content.

16. The method as set forth in claim 15 wherein the first content includes an audio portion and a video portion, which audio portion is not required to understand the video portion.

17. The method as set forth in claim 15 wherein the first content does not include an audio portion.

18. A video platform for concurrently presenting multiple content types, comprising:
a means for receiving a first content associated with a first content type;
a means for receiving a second content associated with a second content type; and
a means for concurrently presenting the first content and the second content in a human viewable display.

19. The television platform as set forth in claim 18, further including:
a means for receiving a user command to select the second content.

20. The television platform as set forth in claim 18, further including:
a means for combining the first content and the second content in a composite screen,
the human viewable display of the second content including a transparent background and overlaying at least a portion of the human viewable display of the first content.
